(19) United States
(12) Patent Application Publication
(10) Pub. No.: US 2007/0091300 A1
(43) Pub. Date: Apr. 26, 2007

(54) Light monitoring device

(75) Inventor: Jonathan Phillip Hall, Towcester (GB)

Correspondence Address: LAHIVE & COCKFIELD, LLP, ONE POST OFFICE SQUARE, BOSTON, MA, 02109-2127, US

(73) Assignee: BOOKHAM TECHNOLOGY, PLC, Towcester (GB)

(21) Appl. No.: 11/515,925

(22) Filed: Sep. 5, 2006

(30) Foreign Application Priority Data
Sep. 6, 2005 (GB) 0518094.8

(51) Int. Cl. G01J 1/42

(52) U.S. Cl. 356/218

(57) ABSTRACT

A monitoring device for monitoring a light beam comprises a filter, first and second photodetectors, and an optical body. The first photodetector is arranged to detect a first portion of the light beam that is transmitted through the filter, and the second photodetector is arranged to detect a second portion of the light beam that is reflected from the filter. At least one of the portions of the light beam is directed to its respective photodetector by total internal reflection within the optical body. The monitoring device may be a wavelength locker.

The present invention relates to the monitoring of a light beam, and in particular the monitoring of the wavelength of a light beam, for example in order to detect and correct any drift in the wavelength from a predetermined wavelength (known as “wavelength locking”). The invention has particular utility in the field of optical communications (and will be described primarily in relation thereto) but at least the broadest aspects of the invention are not limited to optical communications applications.

In this specification, the terms “light” and “optical” will generally be used to refer not only to visible light but also to other wavelengths of electromagnetic radiation, for example in the wavelength range of about 200 nm to about 2000 nm, i.e. from ultraviolet to the near-infrared.

Wavelength lockers are well known and are used, for example, to ensure that an optical signal generated by a laser for transmission over an optical communications network has the correct wavelength. (Wavelength drift may otherwise occur due to ageing effects, temperature variations, or power fluctuations, for example.) This is particularly important, for example, in wavelength division multiplex (WDM) optical communications systems, and is even more important in dense wavelength division multiplex (DWDM) systems, in which a plurality of wavelength channels is used to transmit optical signals via a single optical fibre. If the wavelength of one or more of the optical signals does not fall within its correct pre-assigned wavelength channel, corruption of the signals and/or problems with detection of the signals may occur, for example.

There are currently two principal telecommunications bands, namely the C Band (191.6-196.2 THz) and the L Band (186.4-191.6 THz). Within these bands there are standard wavelength channels defined by the International Telecommunications Union (ITU) at spacings of 100 GHz (0.8 nm), 50 GHz (0.4 nm), or 25 GHz (0.2 nm). (In the future, additional bands, and narrower spacings of wavelength channels within the bands, may be used.) There is therefore a need to “lock” optical signal wavelengths at these standardised wavelengths (and possibly other wavelengths), and wavelength lockers are used for this purpose.

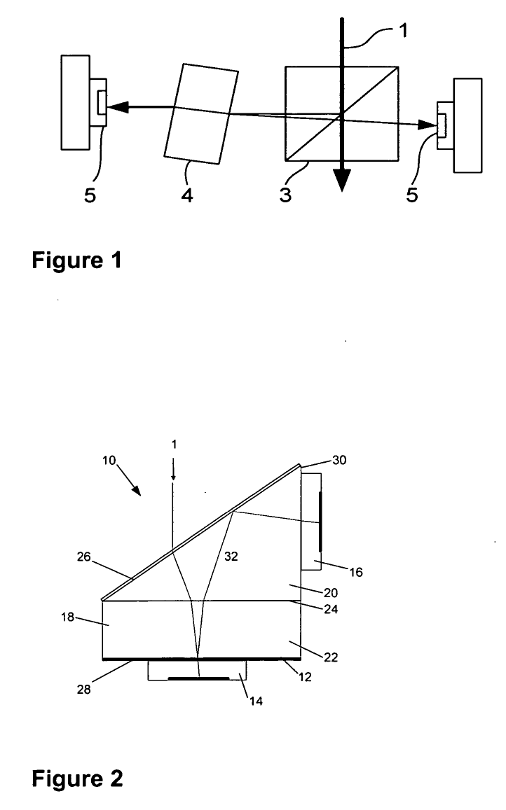

Thus, a wavelength locker typically monitors the light output of a laser and provides electronic feedback to the laser to control its wavelength. The locker typically comprises an etalon and/or other filter, with one or more photodetectors. The etalon or other filter transmits light that is a function of wavelength, and the level of light that is detected by the photodetector can therefore be related to the wavelength. FIG. 1 of the accompanying drawings illustrates, schematically and in plan view, a wavelength locker of the type disclosed in international patent application WO 01/091756 (Bookham Technology), the entire contents of which are incorporated herein by reference. In this wavelength locker, a portion of the light beam 1 emitted from a source (e.g. a laser) is sampled from the beam by a cube-type beam splitter 3, and sampled light that is transmitted or reflected from a separate etalon or other filter 4 is detected by a pair of separate photodetectors 5. The wavelength of the light can be monitored by monitoring the difference between the photodetector signals produced by the two photodetectors. The power of the light can be determined from the sum of the two photodetector signals. In other known wavelength locker designs, one or more light splitting devices may be used, with one light path providing a power level, and another light path using an etalon or other wavelength-selective component to provide a signal for wavelength discrimination, for example.

A great many different wavelength locker designs are known. Examples of some known designs are disclosed in the following patent publications: US2003/0142315; U.S. Pat. Nos. 5,825,792; 6,639,922; U.S.2004/0146077; US2003/0063632; U.S. Pat. No. 6,661,818; WO02/09736; US2002/0181515; U.S. Pat Nos. 6,717,682; 6,487,087; 6,621,580; and 6,353,623.

Prior art wavelength lockers comprise separate components which take a substantial amount of space (e.g. an area of a few tens of mm²) inside an optoelectronics package. Such areas are very large in comparison to integrated optical components such as lasers, with which wavelength lockers are typically used. The available space in an optoelectronics package is normally extremely limited, and there is also a continuing need to reduce the size of such packages. Additionally, during manufacturing it is necessary for each of the components of a wavelength locker to be separately placed, aligned and bonded inside the package. Some of the components need to be aligned with a very high degree of precision, which is consequently expensive, due to the time-cost on the labour and assembly equipment.

The present invention seeks, among other things, to provide a solution to these problems.

Accordingly, a first aspect of the invention provides a monitoring device for monitoring a light beam, comprising a filter, first and second photodetectors, and an optical body, wherein the first photodetector is arranged to detect a first portion of the light beam that is transmitted through the filter, and the second photodetector is arranged to detect a second portion of the light beam that is reflected from the filter, and wherein at least one of the portions of the light beam is directed to its respective photodetector by total internal reflection within the optical body.

The invention has the advantage that by employing total internal reflection within an optical body forming part of the monitoring device, the monitoring device may be more compact than would otherwise be the case, but without the necessity of a complex structure or complex optical coatings. The invention also has the advantage that by using total internal reflection it is possible (as will be apparent from the detailed description of the invention below) to provide a compact device while enabling the angle of incidence of the light beam on the filter to be close to perpendicular (for example, no greater than 20 degrees from the perpendicular). This has the benefit that the performance and quality criteria of the filter can be less stringent, and a wider range of filters can generally be used, than would normally be the case if the angle of incidence were greater.

In some preferred embodiments of the invention, the second portion of the light beam is directed to the second photodetector by total internal reflection within the optical body. Additionally or alternatively, the first portion of the light beam may be directed to the first photodetector by total internal reflection within the optical body.

The optical body may, for example, comprise at least one block of optically transmissive material. Thus, in some embodiments of the invention, the optical body is a single block of material, whereas in other embodiments of the invention the optical body comprises two (or more) blocks (or other pieces) of material. If more than one block of material is used for the optical body, this can have the advantage of enabling the use of differing refractive indices and/or it can facilitate the provision of one or more optical coatings on the optical device (e.g. including the filter in the form of one or more optical coatings).

The optical body preferably comprises a prism, e.g. one in which a cross-section of the prism comprises at least part of a triangle, preferably a right-angled triangle. However, the optical body may, for example, be formed in another prism shape and/or the optical body may be formed from a plurality of prisms, e.g. of differing shapes and/or sizes.

Preferably, the photodetectors are situated adjacent to one or two faces of the optical body. For example, the first photodetector may be situated adjacent to a first face of the optical body, and the second photodetector may be situated adjacent to a second face of the optical body. The first and second faces of the optical body may, for example, be oriented at an angle of greater than 0 degrees and less than 180 degrees, e.g. substantially 90 degrees, with respect to each other. In some preferred embodiments of the invention, each photodetector is attached directly or indirectly to the face of the optical body to which it is adjacent. This has the advantages of compactness and simplicity of construction.

The monitoring device may be arranged such that, in use, the light beam to be monitored enters the optical body through an input face of the optical body, and the total internal reflection within the optical body also occurs at the input face of the optical body. This can also provide the advantages of compactness and simplicity of construction. The input face of the optical body may comprise the hypotenuse of a right-angled triangular prism, for example. More generally, however, the total internal reflection may occur at one, or more than one, face of the optical body. For example, in some preferred embodiments of the invention, the total internal reflection occurs at two faces of the optical body.

In some preferred embodiments of the invention, the filter comprises a thin-film filter. The thin-film filter may, for example, comprise a coating on the optical body. The device may be arranged such that the light beam to be monitored is incident upon the filter at an angle of incidence (i.e. the angle with respect to perpendicular) of no greater than 20 degrees, especially no greater than 15 degrees, e.g. approximately 12 degrees.

The filter preferably is a wavelength-selective filter. Most preferably, the monitoring device comprises a wavelength locker for locking the wavelength of the light beam substantially to a predetermined wavelength.

According to a second aspect, the invention provides a transmitter comprising a laser arranged to emit a light beam, and a monitoring device according to the first aspect of the invention arranged to monitor the light beam emitted by the laser.

It is to be understood that any feature of the first aspect of the invention may be a feature of the second aspect of the invention, and vice versa.

Preferably, the light beam monitored by the monitoring device is emitted from a rear facet of the laser, a front facet of the laser emitting a transmitted light beam. Alternatively, the light beam may be emitted from a front facet of the laser, and the monitoring device or transmitter may include a beam splitter to create a sample portion of the light beam that is monitored by the monitoring device. The beam splitter may advantageously be part of the optical body, e.g. a partially reflective input face of the optical body.

Other preferred and optional features of the invention are described below, and in the dependent claims.

A preferred embodiment of the invention will now be described, by way of example, with reference to the accompanying drawings, of which:

FIG. 1 is a plan view schematic representation of a known wavelength locker;

FIG. 2 is a schematic plan view illustration of a preferred embodiment of a monitoring device according to the invention, which may be a wavelength locker, e.g. of a transmitter according to the invention; and

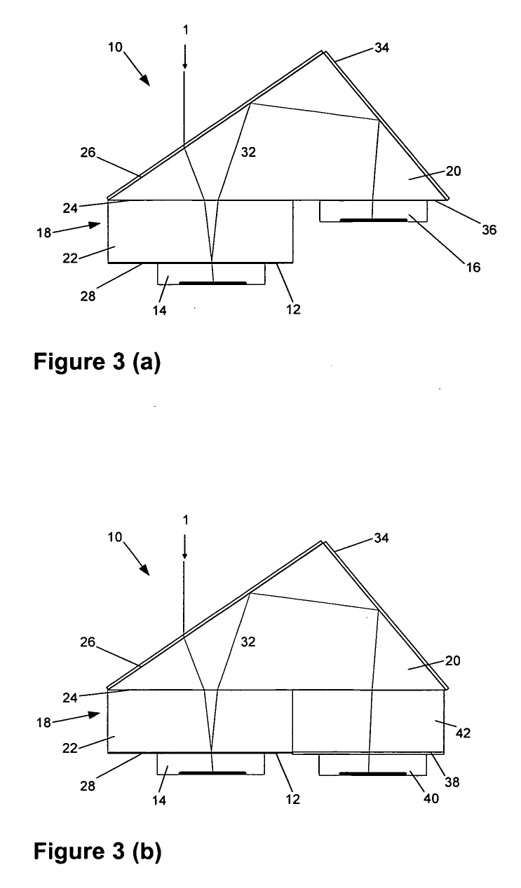

FIG. 3 (views (a) and (b)) shows schematic plan view illustrations of another two preferred embodiments of monitoring device according to the invention, which may be wavelength lockers, e.g. of transmitters according to the invention

FIG. 1, showing a known wavelength locker, has briefly been described above.

FIG. 2 shows a schematic plan view illustration of a preferred embodiment of a monitoring device 10 according to the invention. The monitoring device 10 comprises a filter 12, a first photodetector 14, a second photodetector 16, and an optical body 18. The photodetectors 14 and 16 preferably are photodiodes, and the filter 12 is a wavelength-selective thin-film filter coated onto a first face of the optical body 18. The filter 12 may comprise a plurality of layers.

The optical body 18 comprises a prism in the shape of part of a right-angled triangle, which is formed from a right-angled triangular prism part 20 and a planar (rectangular) part 22 joined together at an interface 24 between the prism part 20 and the planar part 22 (e.g. by means of optical cement or optical contacting). An advantage of forming the optical body 18 from two separate parts that are joined together, is that it is generally easier to coat the filter 12 onto the planar part 22 (as is the case in FIG. 2) before the planar part is joined to the triangular part 20, than it is to coat the filter onto the entire triangular-shaped optical body. The optical body 18 is formed from optically transmissive material, e.g. glass. An input face 26 of the optical body 18, which constitutes the hypotenuse of the triangular prism part 20, preferably is coated with an anti-reflection (i.e. a reflection-inhibiting) coating 26. The triangular prism part 20 and the planar prism part 22 may, for example, have differing refractive indices. For example, the planar part 22 may have a higher refractive index than the triangular part 20. This has two main advantages. Firstly, the planar part 22 can thereby by smaller (in a direction perpendicular to the first face 28) in order to achieve the same optical path lengths through the planar part 22, thereby enabling the optical device and the entire device to be even more compact. Secondly, the input light beam 1 will be incident upon the filter 12 at an angle even closer to perpendicular.

The first photodetector 14 is attached indirectly to a first face 28 of the optical body, the attachment being indirect by virtue of the filter 12 being coated on the first face, and thus situated between the first photodetector and the first face. The second photodetector 16 is attached directly to a second face 30 of the optical body, in a region of the second face 30 that comprises a face of the triangular prism part 20. Consequently the first and second photodetectors 14 and 16 are oriented substantially at 90 degrees with respect to each other.

The photodetectors 14 and 16 may be attached to the optical body 18 for example by means of stand-off bumps or transparent polymer material (e.g. epoxy resin). The optical body 18 may also carry electrical conductors that electrically connect the photodetectors 14 and 16 to electronic equipment that processes their output signals. An interconnection element, e.g. a ceramic tile or other tile, may be attached to the optical body 18, and the interconnection element may also carry electrical conductors connected to the conductors carried by the optical body. In a preferred embodiment the tracking may be solely on a tile.

The monitoring device 10 is arranged to monitor the wavelength of a light beam 1 emitted by a laser or other light source (not shown). As shown in FIG. 2, the first photodetector 14 of the monitoring device 10 is arranged to detect a first portion of the light beam 1 that is transmitted through the filter 12, and the second photodetector 16 is arranged to detect a second portion 32 of the light beam that is reflected from the filter. The device 10 is arranged such that the angle of incidence of the light beam 1 at the filter 12 is less than 20 degrees, e.g. approximately 12 degrees. Consequently, as explained above, the performance requirements for the filter 12 are less stringent than would be the case if the angle of incidence were significantly greater. The second portion 32 of the light beam propagates within the optical device 18, and is incident at the input face 26 of the device at an angle of incidence greater than the critical angle. The second portion 32 of the light beam 1 therefore undergoes total internal reflection at the input face 26, and is thereby directed to the second photodetector 16 attached to the second face 30 of the optical body.

In a conventional manner (for example as disclosed in WO 01/091756) the wavelength of the beam of light 1 may be monitored by monitoring the difference between photodetector signals produced by the first and second photodetectors; the power of the light beam 1 may be determined from the sum of the two photodetector signals. However, by virtue of the use of total internal reflection within the optical body 18, the monitoring device according to the invention, as illustrated in FIG. 2, is able to achieve the functionality of known light monitoring devices (e.g. wavelength lockers, or transmitters incorporating wavelength lockers) in a more compact way, and in a way that does not impose stringent performance requirements on the filter.

Views (a) and (b) of FIG. 3 show two further embodiments of monitoring device 10 according to the invention. These embodiments of the invention enable simplified manufacture, since both photodetectors 14, 16 or 14, 40 (respectively) are on parallel (or co-planar) surfaces of the optical body 18, albeit at the cost of an increased footprint (i.e. an increased area in plan view).

In the monitoring device 10 shown in FIG. 3(a), the second photodetector 16 is mounted directly onto the triangular prism part 20. (The triangular prism part 20 is not a right-angled triangular prism part; however, in other embodiments of the invention, the triangular prism part could be a right-angled triangular prism part.)

In the monitoring device 10 shown in FIG. 3(b), either the same planar part (rectangular prism part) 22 extends further along the surface 24 of the triangular prism part, or a second planar prism part 42 is located next to the part 22, such that the second photodetector 40 can be mounted in substantially the same plane as the first photodetector 14. The extra portion of the planar part 22 can be monolithic (integral) with part 22 but without the filter 12, or it may be separate, in order to make coating the two sections of part 22 easier, in which case the extra portion would preferably be anti-reflection coated, as indicated by reference numeral 38. Alternatively, the whole optical body 18 of the device 10 shown in FIG. 3(b) can be a single (monolithic) part.

In both embodiments illustrated in FIG. 3, the total internal reflection occurs at two faces of the optical body 18, namely the input face 26, and another face 34.

1. A monitoring device for monitoring a light beam, comprising a filter, first and second photodetectors, and an optical body, wherein the first photodetector is arranged to detect a first portion of the light beam that is transmitted through the filter, and the second photodetector is arranged to detect a second portion of the light beam that is reflected from the filter, and wherein at least one of the portions of the light beam is directed to its respective photodetector by total internal reflection within the optical body.

2. A monitoring device according to claim 1, wherein the second portion of the light beam is directed to the second photodetector by total internal reflection within the optical body.

3. A monitoring device according to claim 1, wherein the optical body comprises at least one block of optically transmissive material.

4. A monitoring device according to claim 1, wherein the optical body comprises a prism.

5. A monitoring device according to claim 4, wherein a cross-section of the prism comprises at least part of a triangle.

6. A monitoring device according to claim 5, wherein the cross-section of the prism comprises at least part of a right-angled triangle.

7. A monitoring device according to claim 1, wherein the photodetectors are situated adjacent to a face of the optical body.

8. A monitoring device according to claim 1, wherein the photodetectors are situated adjacent to two faces of the optical body.

9. A monitoring device according to claim 8, wherein the first photodetector is situated adjacent to a first face of the optical body, and the second photodetector is situated adjacent to a second face of the optical body.

10. A monitoring device according to claim 9, wherein the first and second faces of the optical body are oriented at an angle of greater than 0 degrees and less than 180 degrees with respect to each other.

11. A monitoring device according to claim 10, wherein the first and second faces of the optical body are oriented at an angle of approximately 90 degrees with respect to each other.

12. A monitoring device according to claim 8, wherein each photodetector is attached directly to the face of the optical body to which it is adjacent.

13. A monitoring device according to claim 8, wherein each photodetector is attached indirectly to the face of the optical body to which it is adjacent.

14. A monitoring device according to claim 1, wherein the device is arranged such that, in use, the light beam to be monitored enters the optical body through an input face of the optical body, and the total internal reflection within the optical body also occurs at the input face of the optical body.

15. A monitoring device according to claim 14, wherein the optical body comprises a prism that in cross-section has the shape of a right-angled triangle, and wherein the input face of the optical body comprises the hypotenuse of the prism.

16. A monitoring device according to claim 1, wherein the filter comprises a thin-film filter.

17. A monitoring device according to claim 16, wherein the thin-film filter comprises a coating on the optical body.

18. A monitoring device according to claim 16, wherein the device is arranged such that the light beam to be monitored is incident upon the filter at an angle of incidence of no greater than 20 degrees.

19. A monitoring device according to claim 1, wherein the total internal reflection occurs at at least one face of the optical body.

20. A monitoring device according to claim 1, comprising a wavelength locker for locking the wavelength of the light beam substantially to a predetermined wavelength.

21. A transmitter comprising a laser arranged to emit a light beam, and a monitoring device according to claim 1 arranged to monitor the light beam emitted by the laser.

22. A transmitter according to claim 21, in which the light beam monitored by the monitoring device is emitted from a rear facet of the laser, a front facet of the laser emitting a transmitted light beam.
